(19) United States
(12) Patent Application Publication
(10) Pub. No.: US 2011/0223550 A1
(43) Pub. Date: Sep. 15, 2011

(54) METHOD OF AFFIXING HEAT-RESISTANT FUEL ACTIVATION SUBSTANCE AND COMBUSTION DEVICE

(75) Inventors: Seitaro Takahashi, Chiba (JP); Masahiro Ito, Saitama (JP)

(73) Assignee: FIRE UP LTD., Tokyo (JP)

(21) Appl. No.: 13/121,373

(22) PCT Filed: Sep. 15, 2009
(86) PCT No.: PCT/JP2009/004590

§ 371 Date: Apr. 27, 2011

(30) Foreign Application Priority Data
Sep. 29, 2008 (JP) 2008-250380

(51) Int. Cl. F23Q 2/32; B23P 11/00

(52) U.S. Cl. 431/253; 29/428

(57) ABSTRACT

A heat-resistant fuel-activating substance is affixed to a combustion device such as a boiler in an adequate manner, that is, the substance is affixed in an adequate position over an adequate area, whereby the effect of activating combustion is rapidly, stably, and inexpensively produced. A heat-resistant fuel-activating substance having a spectral emissivity of 0.85 or higher at electromagnetic wavelengths in the range of 3-20 μm is affixed to a combustion device so that the heat-resistant fuel-activating substance is disposed in a position which is located outside or inside the combustion chamber at the back of the flame-generating portion of the burner and rises to at most 300° C. in temperature and that the substance occupies at least 50% of the area of the projected part of the combustion cone.

### TECHNICAL FIELD

The present invention relates to an affixing method in which an affixed place and an affixed area of a heat-resistant fuel-activating substance capable of enhancing a combustion-activating effect are specified in the case of the combustion in combustion devices such as a boiler in which liquid fossil fuels such as heavy oil and kerosene, gas fossil fuels such as LPG and natural gas, and solid fossil fuels such as coal are used as fuels.

Heretofore, various studies have been conducted for the improvement of thermal efficiency at the time of combustion in combustion devices such as boilers. For that purpose, for example, like the invention described in Patent Document 1, there were some proposals to improve burners.

The inventors of the present invention have proposed that combustion efficiency at the time of combustion is improved by activating methane-based molecules in a thermal decomposition region using electromagnetic waves from a fuel-activating substance. That is, methane-based molecules as a kind of active chemical species generated by the thermal decomposition of the fuel during the combustion have an absorption band that absorbs electromagnetic waves with specific electromagnetic wavelengths, specifically around 8 μm (a range approximately 3 to 20 μm). Thus, radiation of the electromagnetic waves in the wavelength region to the methane-based molecules in the thermal decomposition region causes stronger vibration of the methane-based molecules as a kind of active chemical species that are combustion precursors. Thereby, frequency of collision between the methane-based molecules and oxygen molecules in air is enhanced and combustion reactions are accelerated, thus leading to a rise in flame temperature. As a result, combustion efficiency comes closer to that of complete combustion, thus realizing a reduction in the amount of the fuel use. The present inventors have tried to develop a heat-resistant fuel-activating substance that exhibits a high spectral emissivity in such wavelengths.

For that purpose, focusing on tourmaline having an action of radiating electromagnetic waves, tests of radiating electromagnetic waves from tourmaline to methane-based molecules in a thermal decomposition region were carried out. However, there was no significant effect that enables an improvement in combustion efficiency at the time of combustion.

Based on these findings, the present inventors disclosed an invention described in Patent Document 2. This invention is intended to obtain an energy saving effect by disposing a far infrared ray generator, formed by mixing tourmaline, iron powder and carbon, in a methane gas passageway located before a portion where combustion occurs, thereby activating the fuel.

### Patent Literature

Patent Document 1: JP 11-1707 A
Patent Document 2: WO 2006/088084 A

### SUMMARY OF INVENTION

After the above prior art, focusing particularly on a spectral emissivity, the present inventors have intensively made an improvement of a fuel-activating substance and found that a flame temperature rise of 100 to 150° C. is obtained by using a fuel-activating material in which a spectral emissivity of electromagnetic waves in the above wavelength region becomes 0.85 or more and radiating electromagnetic waves in the relevant wavelength region to methane-based molecules in the thermal decomposition region.

By the way, a conventional fuel-activating substance is prepared by forming an activating material into a sheet using an organic resin such as a urethane resin as a binder, or by forming the activating material into a coating material to be affixed by coating. Therefore, in case the fuel-activating substance is affixed to a place at high temperature of 100° C. or more in a combustion device, the binder was sometimes carbonized with a lapse of time, resulting in decrease of a spectral emissivity of the electromagnetic waves from the fuel-activating substance.

Moreover, in the case of affixing the fuel-activating substance disclosed in the prior art in a combustion device, conventionally, the substance had to be affixed only outside the combustion device in which flame was burning. This reason is that, since the substance was formed with main components such as tourmaline, iron powder and carbon and were formed using, and an organic resin such as a urethane resin as a binder, when the obtained material was attached to the place where the temperature became as high as 100° C. or more, particularly inside a combustion device, carbonization occurred and caused a decrease in spectral emissivity.

However, the temperature sometimes became as high as 100° C. or more even at outside the combustion device, and thus the fuel-activating substance could not sometimes be affixed at such a place. Therefore, it was an object to provide the fuel-activating substance with heat resistance.

Then, if the fuel-activating substance is provided with more excellent heat resistance than before, it also becomes possible to attach it inside the combustion device, where it has been unable to be affixed so far.

That is, since electromagnetic waves emitted from the fuel-activating substance affixed outside the combustion device have to pass through a metal wall constituting the combustion device in order to reach the combustion flame, attenuation of the quantity of the electromagnetic waves are inevitable, and thus it sometimes takes a long time for a combustion-activating effect to be exerted and also its effect is unstable.

Therefore, an object of the present invention is to exert a combustion-activating effect quickly and stably at low cost by employing a suitable affixing method in the case of affixing a heat-resistant fuel-activating substance to a combustion device such as a boiler.

In light of the above object, In a method of affixing a heat-resistant fuel-activating substance according to the first invention among the present invention, a heat-resistant fuel-activating substance having a spectral emissivity of 0.85 or more for electromagnetic waves with wavelengths in a range of 3 μm to 20 μm is affixed onto a burning appliance, and the heat-resistant fuel-activating substance is affixed in a position which is located outside a combustion device at a back of a combustion flame-generating portion of a burner which constitutes this combustion device so that the substance occupies 50% or more of an area of a projected part of a combustion cone which constitutes this combustion device.

Then, it is preferable that the burner is fixed to a flange portion which constitutes the combustion device, that this flange portion is fixed to this combustion device so that this burner is mounted in this combustion device, and that the position which is located outside the combustion device corresponds to a position outside the combustion device at the flange portion fixed to this combustion device.

Moreover, In a method of affixing a heat-resistant fuel-activating substance according to the second invention among the present invention, a heat-resistant fuel-activating substance having a spectral emissivity of 0.85 or more for electromagnetic waves with wavelengths in a range of 3 μm to 20 μm is affixed onto a burning appliance, and the heat-resistant fuel-activating substance is affixed in a position which is located inside a combustion device at a back of a combustion flame-generating portion of a burner which constitutes this combustion device so that the substance occupies 50% or more of an area of a projected part of a combustion cone which constitutes this combustion device.

Then, it is preferable that the burner is fixed to a flange portion which constitutes the combustion device, that this flange portion is fixed to this combustion device so that this burner is mounted in this combustion device, and that the position which is located inside the combustion device corresponds to a position inside the combustion device at the flange portion fixed to this combustion device.

The “burning appliances” in the present invention specifically refer to not only a once-through boiler, a flame-tube smoke-tube boiler and a water-tube boiler (including an industrial boiler and a power station boiler that are equipped with two or more burners), but also appliances equipped with a combustion device that uses combustion flame as a heat source, and a combustion chamber, such as a kiln, a dryer, and a hot and chilled water generator.

Moreover, the “combustion device” as used herein refers to an apparatus that is equipped with a fuel supply system, a measuring instrument, various control valves and burners, and is directly involved in combustion.

Furthermore, the “combustion chamber” as used herein refers to a portion where a fuel blown from a burner quickly undergoes ignition or combustion and the generated combustible gas undergoes combustion by satisfactory mixing and contacting with air.

In addition, the “burner” as used herein refers to a liquid fuel burner, a gas fuel burner and a solid fuel burner, and is specifically as follows.

The liquid fuel burner atomizes a fuel oil thereby increasing the surface area and accelerates vaporization thereby enabling satisfactory contact with air, thus completing a combustion reaction, and specifically refers to a pressure spraying-type burner, a steam (air) spraying-type burner, a low-pressure air atomizing-type burner, a rotary burner, a gun type burner and the like.

The gas fuel burner often utilizes a diffusion combustion system, and specifically refers to a center-type burner, a ring-type burner, a multispud burner and the like.

The solid fuel burner specifically refers to a burner of a pulverized coal burner combustion system.

Moreover, there is no limitation on the kind of the “heat-resistant fuel-activating substance” in the present invention, as long as it has a spectral emissivity of 0.85 or more for electromagnetic waves with wavelengths in a range of 3 μm to 20 μm and also exhibits a performance that enables use in a state where the temperature is from a normal temperature to 300° C. This spectral emissivity is a numerical value assumed that an emissivity in the relevant wavelength range of a blackbody is 1, and has significance as a numerical value enough to radiate far infrared rays contributing to activation of methane-based molecules in a thermal decomposition region.

Specific examples of this fuel-activating substance include those containing fuel-activating materials such as tourmaline, iron powder and carbon as main components. Silicon may be added thereto as the fuel-activating material. These fuel-activating materials are melt-mixed with a metallic thermal spray material as a binder, for example, fine powders of metals having a low melting temperature, such as copper, aluminum and nickel and the obtained melt mixture is sprayed to the above position of the outside or the inside of a combustion chamber, thus making it possible to form a heat-resistant fuel-activating substance film. It is also possible to form a heat-resistant fuel-activating substance film by melt-mixing these fuel-activating materials with metals having a comparatively low melting point, such as lead and zinc, forming the melt mixture into a sheet, and affixing the obtained sheet to the similar position. Furthermore, it is possible to form a heat-resistant fuel-activating substance film by kneading these fuel-activating materials with an inorganic resin, as a binder, containing partially or entirely inorganic materials such as silicone, fluorine and soluble glass as a component, and spraying or coating the obtained kneaded mixture to the above portion of the outside or inside of a combustion chamber, or kneading the above materials, forming the kneaded mixture into a sheet and applying the obtained sheet to the similar position.

Providing that a maximum diameter portion of a combustion cone of a burner is projected to a fixed portion of the burner rearward in a combustion chamber, particularly to a portion including a flange portion, the position and the area, to which the heat-resistant fuel-activating substance is affixed, occupy 50% or more of the projected portion. Herein, this “area” refers to an area calculated assuming that tubes such as a burner and the like and other structures mounted in the area are absent.

With the above constitution of the present invention, a fuel-activating substance is provided with heat resistance that is better than that of the prior art, and thus it becomes possible to attach the material to the inside of a combustion device to which the material could not be affixed in the prior art, and also to exert a fuel activating effect, that is, electromagnetic waves emitted from the heat-resistant fuel-activating substance can directly act combustion flame, by employing a suitable affixing method of affixing the substance to the area that occupies 50% or more of an area of a projected part of a combustion cone project portion in the case of affixing the heat-resistant fuel-activating substance to a combustion device such as a boiler. As a result, vibration of methane-based molecules as a kind of active chemical species generated by thermal decomposition of fuel is activated and the combustion is accelerated, thus exerting the effect of realizing a rise in flame temperature and stable combustion flame and also decreasing the amount of the fuel use, quickly and stably at a low cost.

### BRIEF DESCRIPTION OF DRAWINGS

FIG. 1 schematically shows a measuring device used to examine a relationship between the spectral emissivity and the flame temperature in a heat-resistant fuel-activating substance according to the present invention.

FIG. 2 schematically shows a flame-tube smoke-tube boiler affixed with a heat-resistant fuel-activating substance as a first embodiment of the present invention.

FIG. 3 enlarges a burner portion in FIG. 2.

FIG. 4 is a graph showing a change in a fuel use coefficient before and after affixing the heat-resistant fuel-activating substance that occupies 100% of an area of a projected part of a cone maximum diameter portion in an outer side face of a combustion chamber in the first embodiment of the present invention.

FIG. 5 is a graph showing a change in a fuel use coefficient before and after affixing the heat-resistant fuel-activating substance that occupies 100% of an area of a projected part of a cone maximum diameter portion in an inner side face of a combustion chamber in the first embodiment of the present invention.

FIG. 6 schematically shows a once-through boiler affixed with a heat-resistant fuel-activating substance as a second embodiment of the present invention.

FIG. 7 enlarges a burner portion in FIG. 6.

FIG. 8 is a graph showing a change in a fuel use coefficient before and after affixing the heat-resistant fuel-activating substance that occupies 100% of an area of a projected part of a cone maximum diameter portion in an outer side face of a combustion chamber in the second embodiment of the present invention.

FIG. 9 is a graph showing a change in a fuel use coefficient before and after affixing the heat-resistant fuel-activating substance that occupies 100% of an area of a projected part of a cone maximum diameter portion in an inner side face of a combustion chamber in the second embodiment of the present invention.

FIG. 10 schematically shows a water-tube boiler affixed with a heat-resistant fuel-activating substance as a third embodiment of the present invention.

FIG. 11 enlarges a burner portion in FIG. 10.

FIG. 12 is a graph showing a change in a fuel use coefficient before and after affixing the heat-resistant fuel-activating substance that occupies 100% of an area of a projected part of a cone maximum diameter portion in an outer side face of a combustion chamber in the third embodiment of the present invention.

FIG. 13 is a graph showing a change in a fuel use coefficient before and after affixing the heat-resistant fuel-activating substance that occupies 100% of an area of a projected part of a cone maximum diameter portion in an inner side face of a combustion chamber in the third embodiment of the present invention.

### DESCRIPTION OF EMBODIMENTS

### (1) Verification of Blending Ratio of Fuel Activating Material

The following materials were used as a fuel-activating material.

Tourmaline: Schorl tourmaline, 42 mesh (Adam Kozan Chuo Kenkyusho Co., Ltd.).

Iron powder: RS-200A (POWDER TECH).

Carbon: activated carbon powder (C-AW; 12.011, SHOWA CHEMICAL INDUSTRY CO., LTD.).

The above materials mixed in each blending ratio shown in Table 1 described below was used as the fuel-activating material and an inorganic silicone resin (ES-1002T, Shin-Etsu Chemical Co., Ltd.) as a binder was added thereto. The obtained mixture was kneaded and was thereafter coated on a 2-mm thick aluminized steel sheet so that a thickness of the obtained coating film became 0.6 mm to obtain samples. The obtained samples were subjected to the measurement of the spectral emissivity.

The spectral emissivity was measured using a Fourier transform infrared spectrophotometer of Shimadzu (IRPrestiga-21 (P/N206-72010), Shimadzu Corporation). Specifically, first, the spectral emissivity was read as 1.0 by a blackbody furnace (at 300° C.) and a measuring sample coated with a pseudo-blackbody coating material (spectral emissivity: 0.94) was then placed in a sample furnace. The spectral emissivity was set to 0.94 at a temperature in the sample furnace. Thereafter, each sample was placed in the sample furnace under this condition and the spectral emissivity was measured. The results were also shown in Table 1 below.

TABLE 1

| Sample | Tourmaline | | Iron powder | | Carbon | | Total | Binder | | Spectral |
|---|---|---|---|---|---|---|---|---|---|---|
| No. | g | % | g | % | g | % | g | g | % | emissivity |
| 1 | 150 | 22.5% | 508 | 76.0% | 10 | 1.5% | 668 | 668 | 100% | 0.77 |
| 2 | 201 | 30.1% | 458 | 68.6% | 9 | 1.3% | 668 | 668 | 100% | 0.92 |
| 3 | 240 | 35.9% | 420 | 62.9% | 8 | 1.2% | 668 | 668 | 100% | 0.94 |
| 4 | 293 | 43.9% | 368 | 55.1% | 7 | 1.0% | 668 | 668 | 100% | 0.89 |
| 5 | 320 | 47.9% | 344.5 | 51.6% | 3.5 | 0.5% | 668 | 668 | 100% | 0.72 |
| 6 | 308 | 46.1% | 350 | 52.4% | 10 | 1.5% | 668 | 668 | 100% | 0.78 |
| 7 | 291.5 | 43.6% | 367.5 | 55.0% | 9 | 1.3% | 668 | 668 | 100% | 0.91 |
| 3 | 240 | 35.9% | 420 | 62.9% | 8 | 1.2% | 668 | 668 | 100% | 0.94 |
| 8 | 203 | 30.4% | 460 | 68.9% | 5 | 0.7% | 668 | 668 | 100% | 0.87 |
| 9 | 184 | 27.5% | 480.5 | 71.9% | 3.5 | 0.5% | 668 | 668 | 100% | 0.70 |
| 10 | 243 | 36.4% | 424 | 63.5% | 1 | 0.1% | 668 | 668 | 100% | 0.75 |
| 11 | 242.5 | 36.3% | 422 | 63.2% | 3.5 | 0.5% | 668 | 668 | 100% | 0.90 |
| 3 | 240 | 35.9% | 420 | 62.9% | 8 | 1.2% | 668 | 668 | 100% | 0.94 |
| 12 | 239 | 35.8% | 419 | 62.7% | 10 | 1.5% | 668 | 668 | 100% | 0.89 |
| 13 | 236 | 35.3% | 417 | 62.4% | 15 | 2.2% | 668 | 668 | 100% | 0.74 |

*Percentages are % by weight based on the total.

As shown in the above results, the spectral emissivity of Sample No. 3, in which the amount of tourmaline in the fuel-activating material was 240 g (35.9% by weight), the amount of iron powder was 420 g (62.9% by weight) and the amount of carbon was 8 g (1.2% by weight), was 0.94, which was considered to be the best mode. Using this sample as a center value, when the blending ratio of tourmaline was 30% by weight or more and 44% by weight or less (from Samples No. 2 and No. 4), the blending ratio of iron powder was 55% by weight or more and 69% by weight or less (from Samples No. 7 and No. 8) and the blending ratio of carbon was 0.5% by weight or more and 1.5% by weight or less (from Samples No. 11 and No. 12), the spectral emissivity was found to become 0.85 or more.

### (2) Heat-Resistant Fuel-Activating Substance Formed by Metal Spraying

Next, an appropriate weight ratio of a binder for metal spraying was examined using the fuel-activating material of Sample No. 3, which was considered as the best mode by the results of (1) described above.

Metallizing 29029 as a binder (Eutectic of Japan Ltd.) containing nickel and aluminum as main components in the weight ratio shown in Table 2 below was melt-mixed with 100% by weight of the fuel-activating material of Sample No. 3 described above, and then the obtained melt mixture was thermally sprayed onto a 2-mm thick aluminized steel sheet so that a thickness of the obtained coating film became 0.6 mm, using Tero-Dizing System 2000 (Eutectic of Japan Ltd.). With respect to the heat-resistant fuel-activating substance formed by this thermal spraying, the spectral emissivity was measured in the same manner as in (1) described above and also adhesion to the thermal sprayed site was examined. The results were as shown in Table 2 below.

TABLE 2

| Sample | Tourmaline | | Iron powder | | Carbon | | Total | Binder | | Spectral |
|---|---|---|---|---|---|---|---|---|---|---|
| No. | g | % | g | % | g | % | g | g | % | emissivity |
| 14 | 240 | 35.9% | 420 | 62.9% | 8 | 1.2% | 668 | 300 | 45% | — |
| 15 | 240 | 35.9% | 420 | 62.9% | 8 | 1.2% | 668 | 334 | 50% | 0.91 |
| 16 | 240 | 35.9% | 420 | 62.9% | 8 | 1.2% | 668 | 668 | 100% | 0.94 |
| 17 | 240 | 35.9% | 420 | 62.9% | 8 | 1.2% | 668 | 1000 | 150% | 0.90 |
| 18 | 240 | 35.9% | 420 | 62.9% | 8 | 1.2% | 668 | 1150 | 172% | 0.72 |

*Percentages are % by weight based on the total.

As shown in the above results, the spectral emissivity of Sample No. 16 in which the weight ratio of the binder compared to 100% by weight of the fuel-activating material is 100% by weight is the highest value of 0.94 and, using this sample as a center value, the spectral emissivity of Sample No. 15, in which the weight ratio of the binder is 50% by weight, and that of Sample No. 17 in which the weight ratio of the binder is 150% by weight were 0.85 or more. To the contrary, in Sample No. 18 in which the weight ratio of the binder is more than 150%, the spectral emissivity was less than 0.85. In Sample No. 14 in which the weight ratio of the binder is less than 50% by weight, when the sample was rubbed by hands after thermal spraying onto the steel sheet, the spray coating film was easily peeled off. As a result, it has been found that the sample showed poor adhesion performance as the heat-resistant fuel-activating substance and was not suited for practical use.

As described above, in the case of forming a heat-resistant fuel-activating substance by mixing with the binder for metal spraying, an appropriate weight ratio of the binder compared to 100% by weight of the fuel-activating material is 50% by weight or more and 150% by weight or less.

### (3) Heat-Resistant Fuel-Activating Substance Formed as Metal Sheet

Next, an appropriate weight ratio of a binder for forming into a metal sheet was examined using the fuel-activating material of Sample No. 3, which was considered as the best mode by the results of (1) described above.

Lead as a binder in the weight ratio shown in Table 3 below was blended with 100% by weight of the fuel-activating material of Sample No. 3 described above, and then the obtained mixture was melted at 350° C. and formed into a 1-mm thick sheet. The spectral emissivity of the sheet was measured in the same manner as in (1) described above and also formability as the sheet was examined. The results were as shown in Table 3 below.

TABLE 3

| Sample | Tourmaline | | Iron powder | | Carbon | | Total | Binder | | Spectral |
|---|---|---|---|---|---|---|---|---|---|---|
| No. | g | % | G | % | g | % | g | g | % | emissivity |
| 19 | 240 | 35.9% | 420 | 62.9% | 8 | 1.2% | 668 | 300 | 45% | — |
| 20 | 240 | 35.9% | 420 | 62.9% | 8 | 1.2% | 668 | 334 | 50% | 0.90 |
| 21 | 240 | 35.9% | 420 | 62.9% | 8 | 1.2% | 668 | 668 | 100% | 0.94 |
| 22 | 240 | 35.9% | 420 | 62.9% | 8 | 1.2% | 668 | 1000 | 150% | 0.88 |
| 23 | 240 | 35.9% | 420 | 62.9% | 8 | 1.2% | 668 | 1150 | 172% | 0.70 |

*Percentages are % by weight based on the total.

As shown in the above results, the spectral emissivity of Sample No. 21 in which the weight ratio of the binder compared to 100% by weight of the fuel-activating material is 100% by weight is the highest value of 0.94 and, using this sample as a center value, the spectral emissivity of Sample No. 20 in which the weight ratio of the binder is 50% by weight, and that of Sample No. 22 in which the weight ratio of the binder is 150% by weight were 0.85 or more. To the contrary, in Sample No. 23 in which the weight ratio of the binder is more than 150%, the spectral emissivity was less than 0.85. In Sample No. 19 in which the weight ratio of the binder is less than 50% by weight, it was impossible to form into a sheet. As a result, it has been found that the sample was not suited for practical use as a heat-resistant fuel-activating substance.

As described above, in the case of forming a heat-resistant fuel-activating substance by mixing with a metal binder and forming the mixture into a sheet, an appropriate weight ratio of the binder compared to 100% by weight of the fuel-activating material is 50% by weight or more and 150% by weight or less.

### (4) Heat-Resistant Fuel-Activating Substance Formed as Inorganic Resin Sheet

Next, in the case of forming into a sheet using the fuel-activating material of Sample No. 3, which was considered as the best mode by the results of (1) described above, and using an inorganic resin as a binder, a suitable weight ratio of the binder was examined. The inorganic silicone resin used also in (1) described above as an inorganic resin in the weight ratio shown in Table 3 below was blended with 100% by weight of the fuel-activating material of (1) described above, and then the obtained mixture was kneaded and formed into a 1-mm thick sheet. The spectral emissivity of the sheet was measured in the same manner as in (1) described above and also formability as the sheet was examined. The results were as shown in Table 4 below.

TABLE 4

| Sample | Tourmaline | | Iron powder | | Carbon | | Total | Binder | | Spectral |
|---|---|---|---|---|---|---|---|---|---|---|
| No. | g | % | g | % | g | % | g | g | % | emissivity |
| 24 | 240 | 35.9% | 420 | 62.9% | 8 | 1.2% | 668 | 470 | 70% | — |
| 25 | 240 | 35.9% | 420 | 62.9% | 8 | 1.2% | 668 | 500 | 75% | 0.91 |
| 26 | 240 | 35.9% | 420 | 62.9% | 8 | 1.2% | 668 | 688 | 100% | 0.94 |
| 27 | 240 | 35.9% | 420 | 62.9% | 8 | 1.2% | 668 | 1000 | 150% | 0.90 |
| 28 | 240 | 35.9% | 420 | 62.9% | 8 | 1.2% | 668 | 1150 | 172% | 0.71 |

*Percentages are % by weight based on the total.

As shown in the above results, the spectral emissivity of Sample No. 26 in which the weight ratio of the binder compared to 100% by weight of the fuel-activating material is 100% by weight is the highest value of 0.94 and, using this sample as a center value, the spectral emissivity of Sample No. 25 in which the weight ratio of the binder is 75% by weight, and that of Sample No. 27 in which the weight ratio of the binder is 150% by weight were 0.85 or more. To the contrary, in Sample No. 28 in which the weight ratio of the binder is more than 150%, the spectral emissivity was less than 0.85. In Sample No. 24 in which the weight ratio of the binder is less than 75% by weight, it was impossible to form into a sheet. As a result, it has been found that the sample was not suited for practical use as a heat-resistant fuel-activating substance.

As described above, in the case of forming a heat-resistant fuel-activating substance by mixing with an inorganic resin binder and forming the mixture into a sheet, an appropriate weight ratio of the binder compared to 100% by weight of the fuel-activating material is 75% by weight or more and 150% by weight or less.

### (5) Heat-Resistant Fuel-Activating Substance Formed As Inorganic Resin Melt Thermal Spraying Sheet

Next, in the case of forming into a sheet by melting and thermal spraying using the fuel-activating material as Sample No. 3, which was considered as the best mode by the results of (1) described above, and using an inorganic resin as a binder, a suitable weight ratio of the binder was examined. The inorganic silicone resin used also in (1) described above as an inorganic resin in the weight ratio shown in Table 3 below was blended with 100% by weight of the fuel-activating material of (1) described above, and then the obtained mixture was melted and thermally sprayed onto a 2-mm thick aluminized steel sheet so that the film thickness became 1 mm. The spectral emissivity of the sheet was measured in the same manner as in (1) described above and also adhesion as the sheet was examined. The results were as shown in Table 5 below.

TABLE 5

| Sample | Tourmaline | | Iron powder | | Carbon | | Total | Binder | | Spectral |
|---|---|---|---|---|---|---|---|---|---|---|
| No. | g | % | g | % | g | % | g | g | % | emissivity |
| 29 | 240 | 35.9% | 420 | 62.9% | 8 | 1.2% | 668 | 470 | 70% | — |
| 30 | 240 | 35.9% | 420 | 62.9% | 8 | 1.2% | 668 | 500 | 75% | 0.89 |
| 31 | 240 | 35.9% | 420 | 62.9% | 8 | 1.2% | 668 | 668 | 100% | 0.94 |
| 32 | 240 | 35.9% | 420 | 62.9% | 8 | 1.2% | 668 | 1000 | 150% | 0.87 |
| 33 | 240 | 35.9% | 420 | 62.9% | 8 | 1.2% | 668 | 1150 | 172% | 0.72 |

*Percentages are % by weight based on the total.

As shown in the above results, the spectral emissivity of Sample No. 31 in which the weight ratio of the binder compared to 100% by weight of the fuel-activating material is 100% by weight is the highest value of 0.94 and, using this sample as a center value, the spectral emissivity of Sample No. 30 in which the weight ratio of the binder is 75% by weight, and that of Sample No. 32 in which the weight ratio of the binder is 150% by weight were 0.85 or more. To the contrary, in Sample No. 33 in which the weight ratio of the binder is more than 150%, the spectral emissivity was less than 0.85. In Sample No. 29 in which the weight ratio of the binder is less than 75% by weight, when the sample was rubbed by hands after thermal spraying onto a steel sheet, the spray coating film was easily peeled off. As a result, it has been found that the sample showed poor adhesion performance as the heat-resistant fuel-activating substance and was not suited for practical use.

As described above, in the case of forming a heat-resistant fuel-activating substance by subjecting an inorganic resin binder to melting and thermal spraying and forming the melt into a sheet, an appropriate weight ratio of the binder compared to 100% by weight of the fuel-activating material is 75% by weight or more and 150% by weight or less.

### (6) Addition of Silicon

In the case of further adding silicon (silicon powder (Si.14, SHOWA CHEMICAL INDUSTRY CO., LTD.)) to Sample No. 11 in which the content of carbon was the lower limit of 0.5% by weight in (1) described above, samples were made under the same conditions as in (1) described above and then subjected to the measurement of the spectral emissivity. The results were as shown in Table 6 below.

TABLE 6

| Sample | Tourmaline | | Iron powder | | Carbon | | Silicon | | Total | Binder | | Spectral |
|---|---|---|---|---|---|---|---|---|---|---|---|---|
| No. | g | % | g | % | g | % | g | % | g | g | % | emissivity |
| 11 | 242.5 | 36.3% | 422 | 63.2% | 3.5 | 0.5% | 0 | 0.0% | 668 | 668 | 100% | 0.90 |
| 34 | 242.5 | 36.1% | 422 | 62.9% | 3.5 | 0.5% | 3.3 | 0.5% | 671.3 | 668 | 100% | 0.92 |
| 35 | 242.5 | 35.9% | 422 | 62.5% | 3.5 | 0.5% | 6.7 | 1.0% | 674.7 | 668 | 99% | 0.94 |
| 36 | 242.5 | 35.8% | 422 | 62.2% | 3.5 | 0.5% | 10 | 1.5% | 678 | 668 | 99% | 0.91 |
| 37 | 242.5 | 35.7% | 422 | 62.1% | 3.5 | 0.5% | 12 | 1.8% | 680 | 668 | 98% | 0.87 |

*Percentages are % by weight based on the total.

As shown in the above results, the spectral emissivity of Sample No. 11 in which silicon was not added was 0.90, whereas the spectral emissivity was increased to 0.92 in Sample No. 34 in which 0.5% by weight of silicon was added. Furthermore, the spectral emissivity was 0.94 in Sample No. 35 in which 1.0% by weight of silicon was added and the spectral emissivity was 0.91 in Sample No. 36 in which 1.5% by weight of silicon was added. In both samples, the spectral emissivity was increased as compared with the case where silicon was not added. However, the spectral emissivity was rather decreased to 0.87 in Sample No. 37 in which the additive percentage of silicon was more than 1.5% by weight (1.8% by weight).

As described above, when the additive percentage of silicon is 1.5% by weight or less, the significance of supplementing the spectral emissivity was recognized in case the content of carbon is comparatively low.

### (7) Continuous Use of Heat-Resistant Fuel-Activating Substance

Next, an influence of continuous use on the spectral emissivity under a high-temperature environment was examined.

A test piece obtained by coating an aluminum sheet measuring 100 mm×200 mm×2 mm in thickness with the heat-resistant fuel-activating substance of Sample No. 31 in Table 5 described above was placed on a horizontal steel plate supported by a prop, and then heated by a gas ring to a temperature of 280 to 300° C. for 7 hours per day from under the steel plate. After completion of heating, the test piece was subjected to the measurement of the spectral emissivity in the same manner as in (1) described above. This operation was continued for 20 hours with respect to the same test piece.

As a result, a change with time of the spectral emissivity of the test piece was as shown in Table 7 below.

TABLE 7

| | Spectral |
|---|---|
| Elapsed days | emissivity |
| 1 | 0.95 |
| 2 | 0.96 |
| 3 | 0.88 |
| 4 | 0.87 |
| 5 | 0.87 |
| 6 | 0.86 |
| 7 | 0.86 |
| 8 | 0.86 |
| 9 | 0.86 |
| 10 | 0.86 |
| 15 | 0.86 |
| 20 | 0.86 |

As described above, the spectral emissivity was kept at 0.85 or more over the entire test period.

Over the entire test period, blister, peeling or cracking did not occur in the aluminum sheet coated with the heat-resistant fuel-activating substance.

After the measurement of the spectral emissivity, a peeling test was conducted in a state where the temperature was returned to room temperature. Using a cutter, a lattice-shaped cut reaching an aluminum layer was formed on a surface of a heat-resistant fuel-activating substance at an interval of 5 mm, followed by adhering an adhesive cellophane tape thereonto. The tape was peeled off immediately was observed whether the peeled heat-resistant fuel-activating substance adheres onto the tape or not. As a result, over the entire test period, neither peeling of the heat-resistant fuel-activating substance nor any burr was observed at all.

Furthermore, an impact resistance test was conducted with respect to tight adhesion. The same aluminum sheet coated with the heat-resistant fuel-activating substance was placed on a floor and a steel ball of 1 kg was dropped thereon three times from a height of 1 m, and then it was observed whether peeling occurs or not. As a result, any peeling of the heat-resistant fuel-activating substance was not observed over the entire test period.

As shown in each observation described above, tight adhesion of the heat-resistant fuel-activating substance onto a material to be coated is extremely satisfactory.

It is additionally noted herein that the observation results with respect to a change of the spectral emissivity and tight adhesion with time were observed in common not only in mode of use of spraying of the inorganic material of (1) described above, but also in all of other modes of use.

### (8) Relationship Between Spectral Emissivity and Flame Temperature

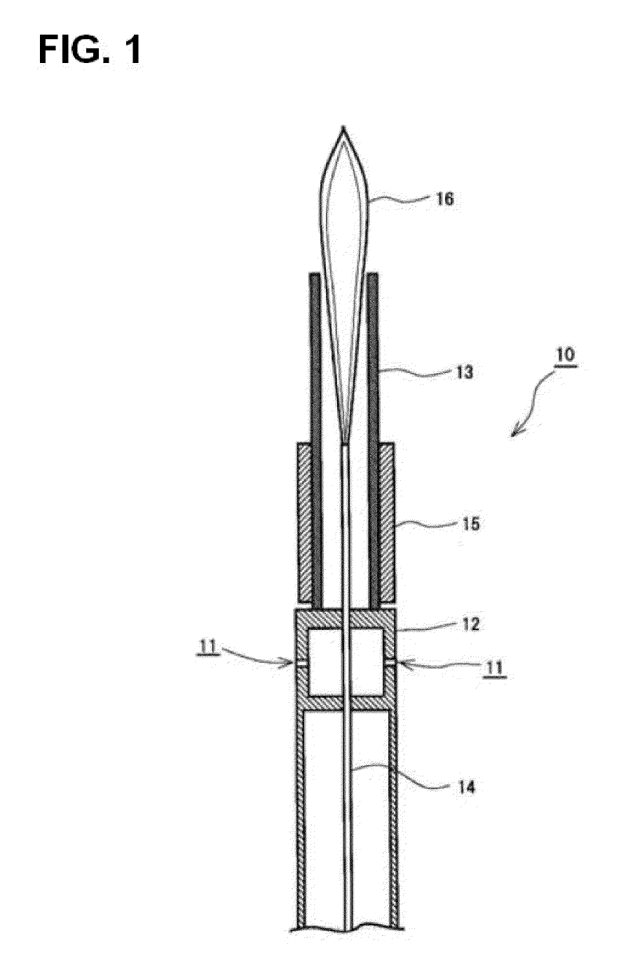

With respect to the presence or absence of affixing of the heat-resistant fuel-activating material, and those having different spectral emissivities among heat-resistant fuel-activating substances, various tests were conducted and a change in flame temperature was examined. Specifically, a measuring device 10 as shown in FIG. 1 was used. That is, a burner 13 made of a stainless steel tube having an inner diameter of 8.0 mm was connected to a burner connection portion 12 equipped with an air hole 11, and also a fuel pipe 14 protrudes from behind the burner connection portion 12 to halfway of the burner cylinder 13. A heat-resistant fuel-activating substance 15 formed into a sheet using the inorganic resin of (4) described above as a binder was affixed on the portion that was an outer side face of this burner cylinder 13 and was also behind a tip of the fuel pipe 14.

This measuring apparatus 10 was disposed at room temperature under an atmospheric pressure and a test was conducted. A flow rate of fuel (city gas (13A, 88% of methane)) from the fuel pipe 14 was adjusted to 73 cm/sec and a flow rate of air from the air hole 11 was adjusted to 27 cm/sec. Flame 16 occurring in the burner cylinder 12 as a result of mixing them was videotaped by a high-speed video camera (HPV-1, Shimadzu Corporation) and the obtained video images were analyzed by a dichroic temperature measurement/camera system (Thermera, Nobby Tech. Ltd.) thereby measuring a flame temperature. The results are shown in Table 8 below.

TABLE 8

| | Affixing of heat- | | |
|---|---|---|---|
| | resistant fuel | Spectral | Flame |
| Test No. | activating substance | emissivity | temperature (K) |
| 1 | Not affixed | — | 2158 |
| 2 | Affixed | 0.70 | 2163 |
| 3 | Affixed | 0.75 | 2163 |
| 4 | Affixed | 0.80 | 2172 |
| 5 | Affixed | 0.85 | 2246 |
| 6 | Affixed | 0.87 | 2246 |
| 7 | Affixed | 0.90 | 2258 |
| 8 | Affixed | 0.92 | 2258 |
| 9 | Affixed | 0.94 | 2258 |

As described above, there was a tendency that the flame temperature rose by affixing of the heat-resistant fuel-activating substance, and also the flame temperature rose as the spectral emissivity of the affixed heat-resistant fuel-activating substance became higher. It has also been found that flame temperature rise of 100 K was particularly observed in the test No. 1 in which the heat-resistant fuel-activating substance was not affixed, and in the tests Nos. 7 to 9 in which the spectral emissivity was 0.90 or more.

As is also apparent from the test of the heat-resistant fuel-activating substance other than (4) described above, the flame temperature depended on the spectral emissivity.

### (9) Test Results in Boiler

The above heat-resistant fuel-activating substance was affixed in a specific boiler and the energy saving efficiency was verified. Herein, the “energy saving efficiency” was defined as follows.

First, a coefficient obtained by dividing the amount of fuel (unit: liter in the case of liquid fuel, m³ in the case of gas fuel) used during the test by the amount of water (unit: m³) used to obtain steam before affixing of the heat-resistant fuel-activating substance was defined as a “fuel use coefficient before affixing” (E_{b}).

On the other hand, a coefficient obtained by dividing the amount of fuel used during the test by the amount of water used to obtain steam after affixing of the heat-resistant fuel-activating substance is similarly defined as a “fuel use coefficient after affixing” (Eₐ).

Then, an energy saving ratio (λ) is defined by the following equation:

λ=(Eb−Ea)/Eb×100.

That is, a ratio (%) of a decrease in amount before and after affixing of the heat-resistant fuel-activating substance of the amount of fuel required to convert 1 cubic meter of water into steam to the amount of fuel required before affixing was the energy saving ratio (λ).

This was verified by various kinds of boilers below.

### (9-1) First Embodiment

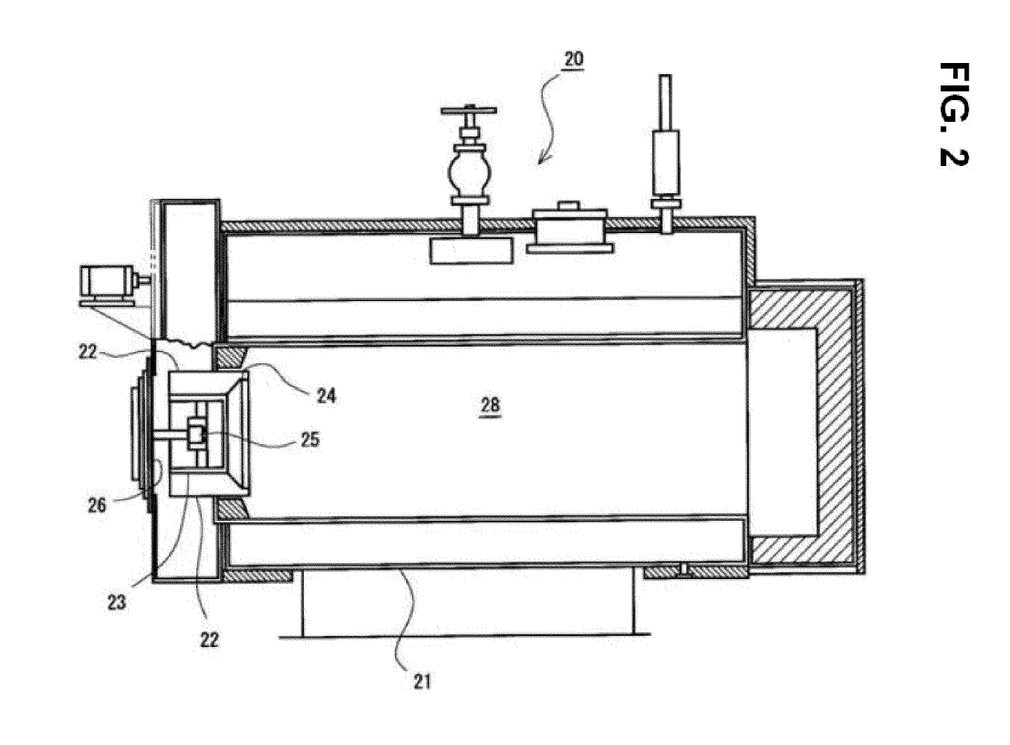

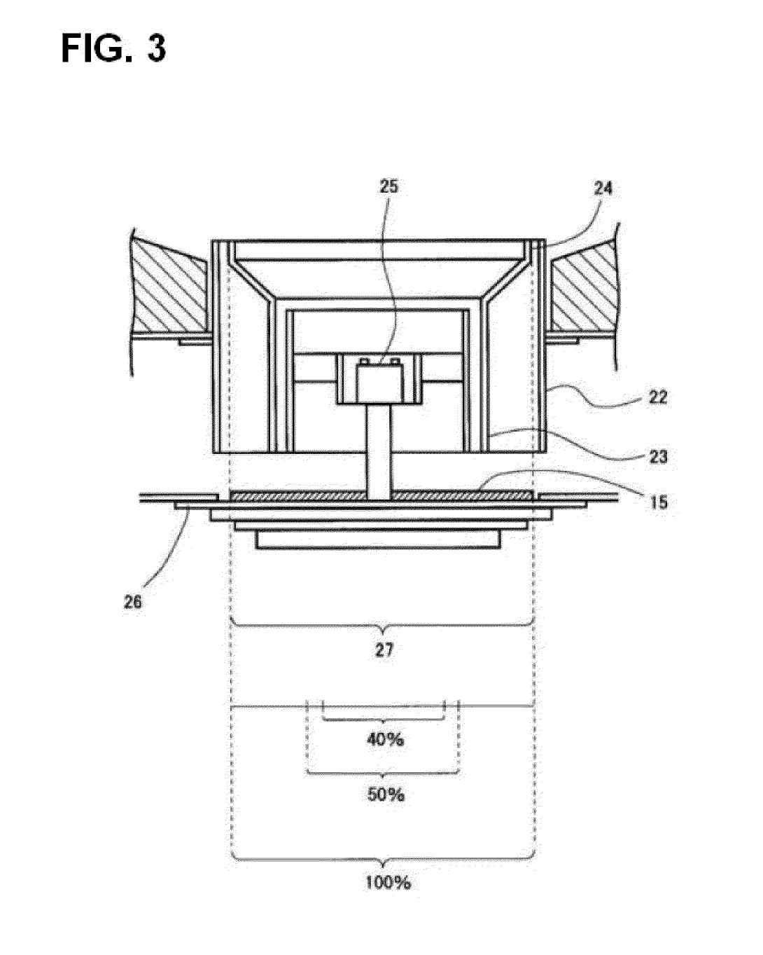

As the first embodiment, verification was conducted using a flame-tube smoke-tube boiler as a specific boiler. The fuel used in this flame-tube smoke-tube boiler (KMS-16A, IHI PACKAGED BOILER CO., LTD.) was A-heavy oil, the burner used was a gun type burner, the boiler capacity was 8,000 kg/h, and the control method was a proportional control method. FIG. 2 is a schematic view of the flame-tube smoke-tube boiler 20, and FIG. 3 enlarges a gun type burner portion thereof. A combustion device 22 was attached to one end (left end in FIG. 2) of a combustion chamber 28 in a boiler body 21, and a combustion cone 23 enabled a cone maximum diameter portion 24 having the maximum outer diameter to open toward inside the boiler body 21 (rightward in FIG. 2, upward in FIG. 3), and emitted flame from the tip of gun type burner 25 located in almost the shaft center to a center direction of a combustion chamber 28. A flange 26 that fixed the gun type burner 25 was provided at the rear end of the combustion device 22. Each kind of heat-resistant fuel-activating substances 15 in Table 9 below was affixed onto the inner side face of the flange 26, whose area 27 was 100% of a projected area of the cone maximum diameter portion 24 to the flange 26 (cf. FIG. 3), and the fuel use coefficient before and after affixing was calculated and then the energy saving ratio was calculated therefrom. The results were shown in Table 9 below. Regarding the spectral emissivity in the heat-resistant fuel-activating substance, the weight ratio of each binder was appropriately adjusted so as to become each numerical value shown in the table below.

TABLE 9

| Method of affixing | | Fuel use coefficient | | Energy |
|---|---|---|---|---|
| heat-resistant fuel- | Spectral | Before | After | saving rate |
| activating substance | emissivity | affixing | affixing | (%) |
| Metal spraying | 0.90 | 72.46 | 68.86 | 4.97 |
| Metal sheet | 0.88 | 72.40 | 68.89 | 4.85 |
| Inorganic resin sheet | 0.94 | 72.30 | 68.46 | 5.31 |
| Inorganic resin | 0.92 | 72.35 | 68.62 | 5.16 |
| thermal spray | | | | |

As described above, even in each of the heat-resistant fuel-activating substances, if the spectral emissivity was 0.85 or more, a decrease of at least 4.85% or more of the fuel use coefficient before affixing was observed. In particular, even if the heat-resistant fuel-activating substance was different, there was a tendency that the energy saving rate also increased with the increase of the spectral emissivity of the heat-resistant fuel-activating substance. This is assumed that the flame temperature may increase with the increase of the spectral emissivity (cf. item (8) in “BEST MODE FOR CARRYING OUT THE INVENTION”).

Next, in the case of affixing an inorganic material sheet that exhibited the highest energy saving ratio among the above to each of an inner side face and an outer side face of a flange 26, which occupied 40%, 50% or 100% of the area of the projected part of a cone maximum diameter portion 24, an energy saving ratio was examined. The results were shown in Table 10 below.

TABLE 10

| | | | Spectral | Fuel use coefficient | | Energy |
|---|---|---|---|---|---|---|
| Test | Affixed | | emis- | Before | After | saving |
| No. | position | Area | sivity | affixing | affixing | rate (%) |
| 1 | Outer side face | 40% | 0.94 | 72.47 | 72.43 | 0.06 |
| 2 | Outer side face | 50% | 0.94 | 72.42 | 69.12 | 4.56 |
| 3 | Outer side face | 100% | 0.94 | 72.36 | 68.67 | 5.10 |
| 4 | Inner side face | 40% | 0.94 | 72.42 | 72.35 | 0.10 |
| 5 | Inner side face | 50% | 0.94 | 72.41 | 69.06 | 4.63 |
| 6 | Inner side face | 100% | 0.94 | 72.30 | 68.46 | 5.31 |

It has been found that the energy saving ratio was less than 1% in the tests No. 1 and No. 4 in which the affixed area is less than 50%, and that these sheets did not endure practical use. On the other hand, in each of tests No. 2, No. 3, No. 5 and No. 6 in which the affixed area was 50% or more, it was possible to achieve the energy saving ratio exceeding at least 4%. As shown from a comparison between the tests No. 2 and No. 3 and a comparison between the tests No. 5 and No. 6, the energy saving ratio increased as the affixed area became larger. Moreover, as shown from a comparison between the tests No. 2 and No. 5 and a comparison between the tests No. 3 and No. 6, when the affixed area was the same, the energy saving ratio increased by affixing to the inner side face of the combustion chamber as compared with the case of affixing to the outer side face.

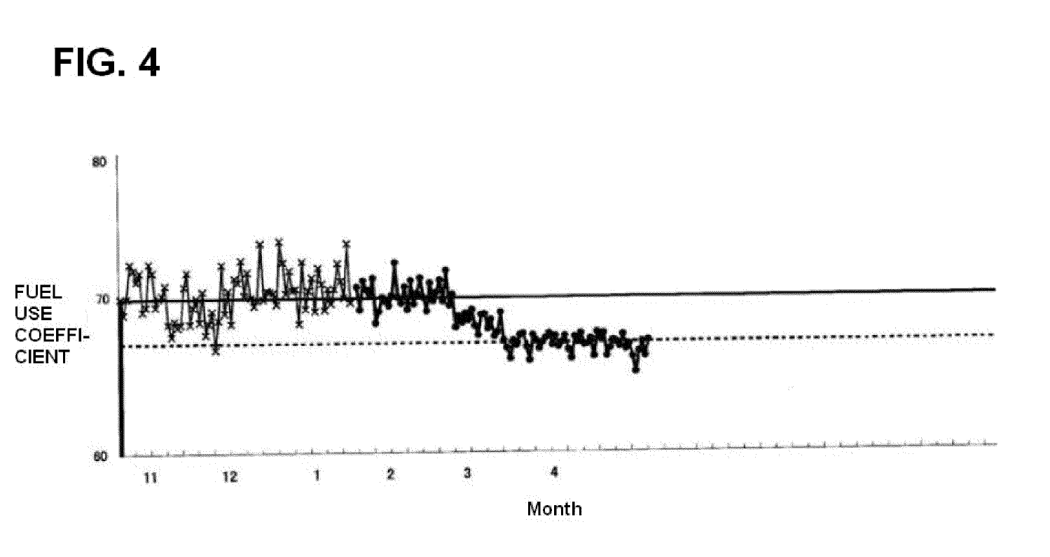

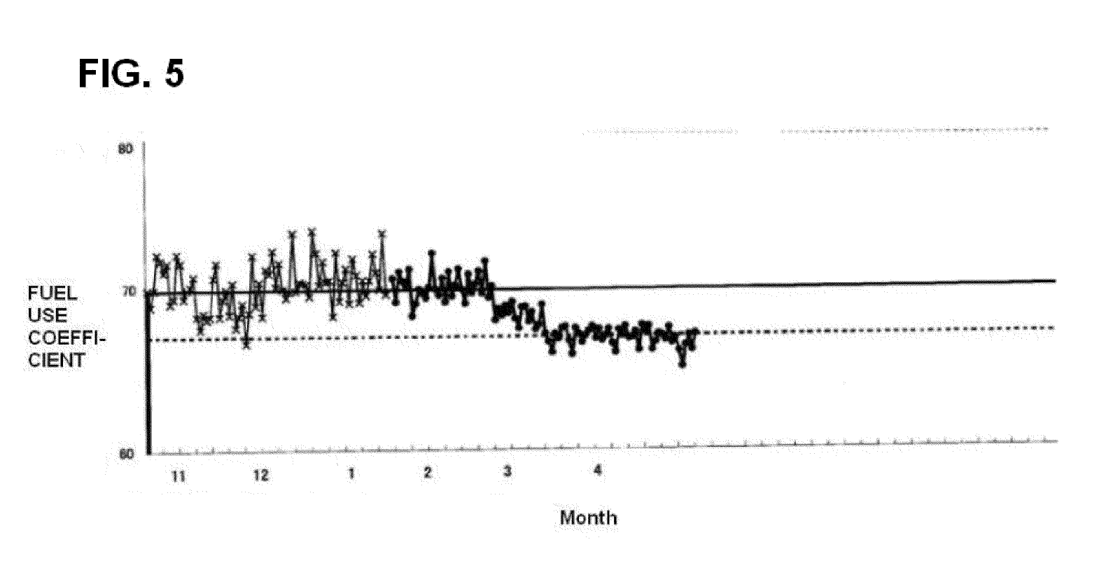

With respect to the tests No. 3 and No. 6 in which the affixed area occupied 100% of the projected area of a cone maximum diameter portion 24, a change in a fuel use coefficient before and after affixing of the heat-resistant fuel-activating substance is shown as a graph in FIG. 4 for the test No. 3, and as a graph in FIG. 5 for the test No. 6. In both FIG. 4 and FIG. 5, an upper solid horizontal lines in the graphs are drawn at the numerical value of the “fuel use coefficient before affixing” in Table 10, while lower broken horizontal lines are drawn at the numerical value of the “fuel use coefficient after affixing” in the same table. In both drawings, the symbol “×” denotes a plot of the fuel use coefficient before affixing of the heat-resistant fuel-activating substance, while the symbol “∘” denotes a plot of a change in the fuel use coefficient after affixing of the heat-resistant fuel-activating substance.

As seen from both of these drawings, the fuel use coefficient stably reached a level of “fuel use coefficient after affixing” within about 1.2 months after affixing in the case of affixing to the inner side face of the combustion chamber (FIG. 5), whereas the fuel use coefficient stably reached a level of “fuel use coefficient after affixing” within about 1.9 months after affixing in the case of affixing to the outer side face of the combustion chamber (FIG. 4). Herein, as shown from Table 10, a distance between the solid horizontal line and the broken horizontal line in FIG. 4 corresponds to 5.10%, whereas that in FIG. 5 corresponds to 5.31%. As seen from above, in the case of affixing to the inner side face of the combustion chamber (FIG. 5), the fuel use coefficient reached lower “fuel use coefficient after affixing” earlier and higher energy saving effect was exerted earlier, as compared with the case of affixing to the outer side face of the combustion chamber (FIG. 4).

### (9-2) Second Embodiment

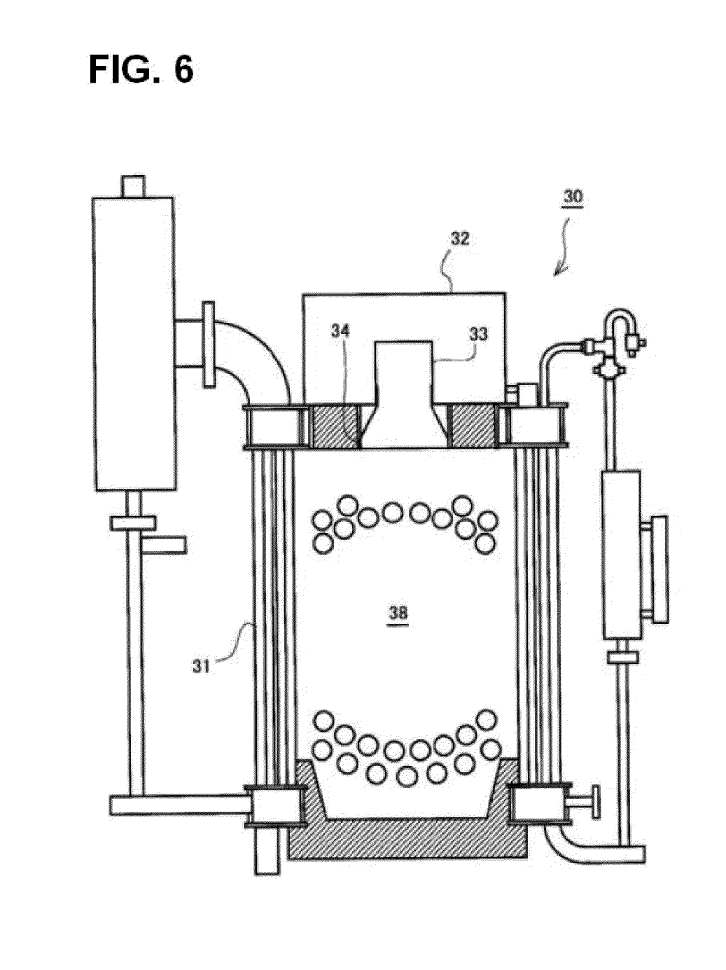

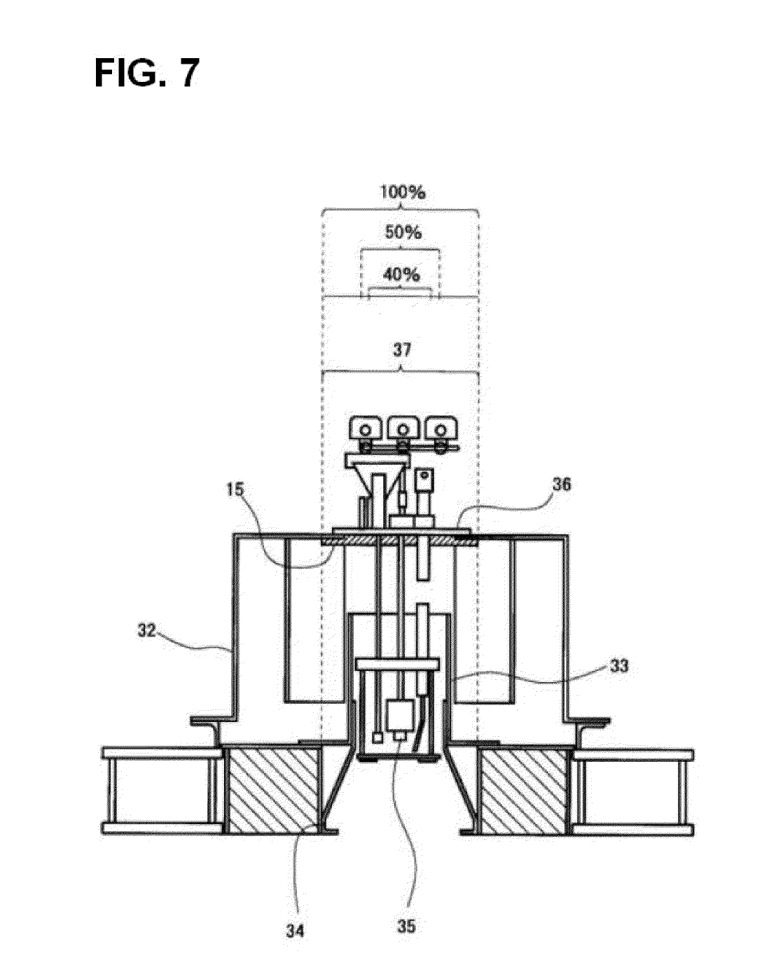

As the second embodiment, verification was conducted using a once-through boiler as a specific boiler. The fuel used in this once-through boiler (STE2001GLM, Nippon Thermoener Co., Ltd.) was LPG, the burner used was a gun type burner, the boiler capacity was 1,667 kg/h, and the control method was a 3-position control method. FIG. 6 is a schematic view of the once-through boiler 30, and FIG. 7 enlarges a gun type burner portion thereof. A combustion device 32 was attached to one end (upper end in FIG. 6) of a combustion chamber 38 in a boiler body 31, and a combustion cone 33 enabled a cone maximum diameter portion 34 having the maximum outer diameter to open toward inside the boiler body 31 (downward in FIG. 6 and FIG. 7), and emitted flame from the tip of gun type burner 35 located in almost the shaft center to a center direction of a combustion chamber 38. A flange 36 that fixed the gun type burner 35 was provided at the rear end of the combustion device 32. Each kind of heat-resistant fuel-activating substances 15 in Table 11 below was affixed onto the inner side face of the flange 36, whose area 37 was 100% of a projected area of the cone maximum diameter portion to the flange 36, and the fuel use coefficient before and after affixing was calculated and then the energy saving ratio was calculated therefrom. The results were shown in Table 11 below. The heat-resistant fuel-activating substances used herein were respectively the same as those used in the first embodiment.

TABLE 11

| Method of affixing | | Fuel use coefficient | | Energy |
|---|---|---|---|---|
| heat-resistant fuel- | Spectral | Before | After | saving rate |
| activating substance | emissivity | affixing | affixing | (%) |
| Metal spraying | 0.90 | 27.14 | 25.80 | 4.94 |
| Metal sheet | 0.88 | 27.12 | 25.83 | 4.76 |
| Inorganic resin sheet | 0.94 | 27.10 | 25.60 | 5.54 |
| Inorganic resin | 0.92 | 27.15 | 25.71 | 5.30 |
| thermal spray | | | | |

As described above, even in each of the heat-resistant fuel-activating substances, if the spectral emissivity was 0.85 or more, a decrease of at least 4.76% or more of the fuel use coefficient before affixing was observed. In particular, even if the heat-resistant fuel-activating substance was different, similar to the first embodiment described above, there was a tendency that the energy saving rate also increased with the increase of the spectral emissivity of the heat-resistant fuel-activating substance.

Next, in the case of affixing an inorganic material sheet that exhibited the highest energy saving ratio, among the above to each of an inner side face and an outer side face of a flange 36, which occupied 40%, 50% or 100% of the area of the projected part of a cone maximum diameter portion 34, an energy saving ratio was examined. The results are shown in Table 12 below.

TABLE 12

| | | | Spectral | Fuel use coefficient | | Energy |
|---|---|---|---|---|---|---|
| Test | Affixed | | emis- | Before | After | saving |
| No. | position | Area | sivity | affixing | affixing | rate (%) |
| 7 | Outer side face | 40% | 0.94 | 27.21 | 27.18 | 0.11 |
| 8 | Outer side face | 50% | 0.94 | 27.18 | 26.19 | 3.64 |
| 9 | Outer side face | 100% | 0.94 | 27.19 | 25.74 | 5.33 |
| 10 | Inner side face | 40% | 0.94 | 27.20 | 27.14 | 0.22 |
| 11 | Inner side face | 50% | 0.94 | 27.17 | 25.88 | 4.75 |
| 12 | Inner side face | 100% | 0.94 | 27.10 | 25.60 | 5.54 |

It has been found that the energy saving ratio was less than 1% in the tests No. 7 and No. 10 in which the affixed area was less than 50%, and that these sheets did not endure practical use. On the other hand, in each of tests No. 8, No. 9, No. 11 and No. 12 in which the affixed area was 50% or more, it was possible to achieve the energy saving ratio exceeding at least 3%. As shown from a comparison between the tests No. 8 and No. 9 and a comparison between the tests No. 11 and No. 12, the energy saving ratio increased as the affixed area became larger. Moreover, as shown from a comparison between the tests No. 8 and No. 11 and a comparison between the tests No. 9 and No. 12, when the affixed area was the same, the energy saving ratio increased by affixing to the inner side face of the combustion chamber as compared with the case of affixing to the outer side face.

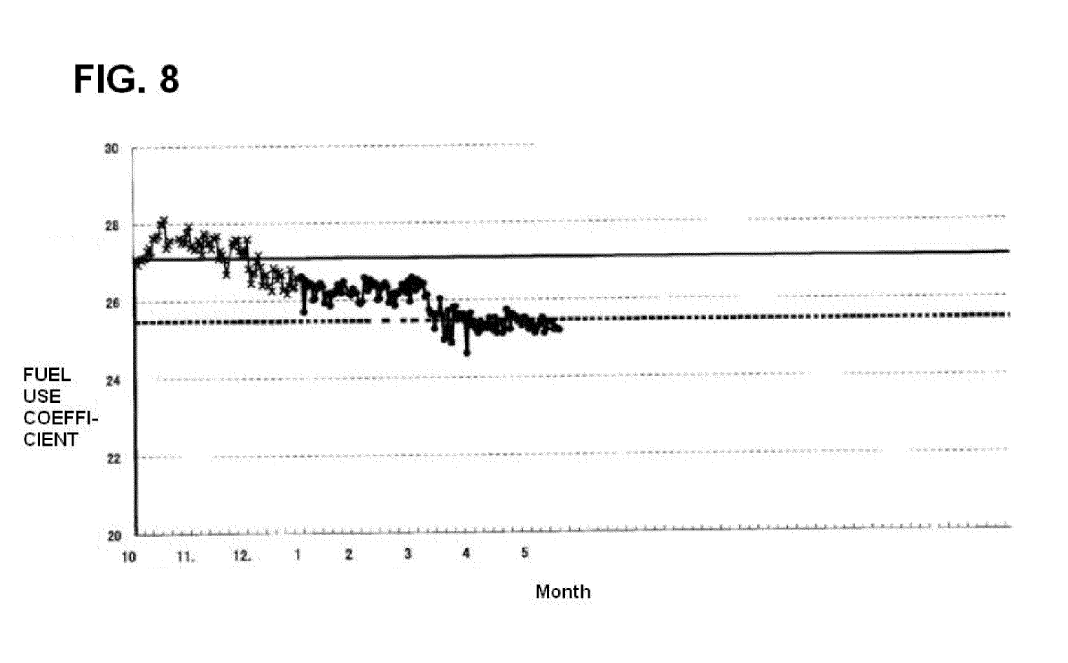

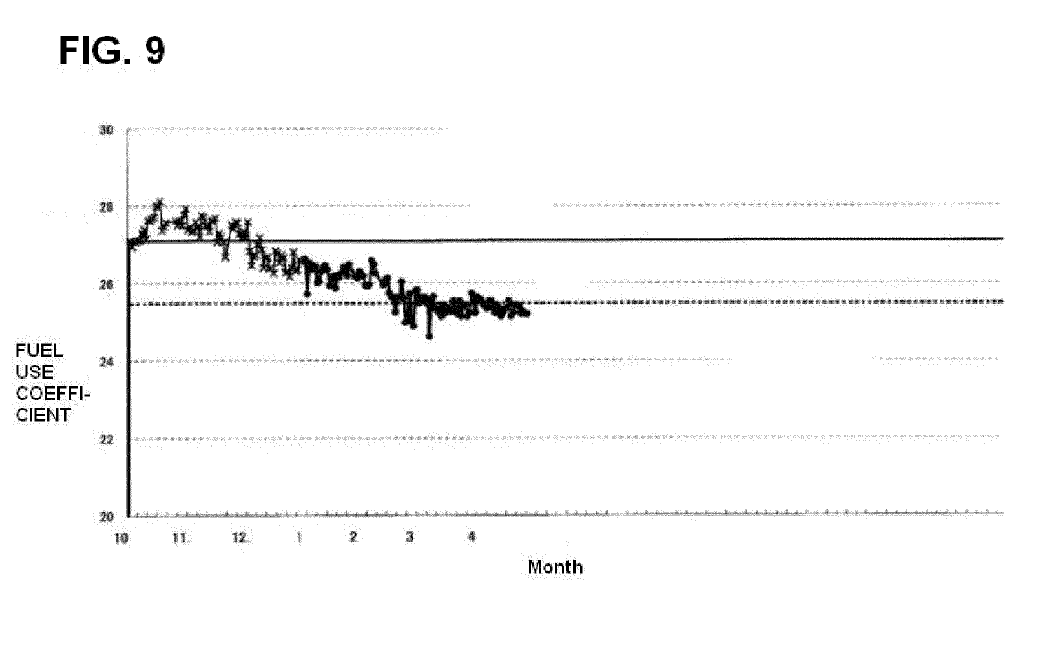

With respect to the tests No. 9 and No. 12 in which the affixed area occupied 100% of the projected area of a cone maximum diameter portion, a change in a fuel use coefficient before and after affixing of the heat-resistant fuel-activating substance is shown as a graph in FIG. 8 for the test No. 9, and as a graph in FIG. 9 for the test No. 12. In both FIG. 8 and FIG. 9, an upper solid horizontal lines in the graphs are drawn at the numerical value of the “fuel use coefficient before affixing” in Table 12, while lower broken horizontal lines are drawn at the numerical value of the “fuel use coefficient after affixing” in the same table. In both drawings, the symbol “×” denotes a plot of the fuel use coefficient before affixing of the heat-resistant fuel-activating substance, while the symbol “∘” denotes a plot of a change in the fuel use coefficient after affixing of the heat-resistant fuel-activating substance.

As seen from both of these drawings, the fuel use coefficient stably reached a level of “fuel use coefficient after affixing” within about 1.5 months after affixing in the case of affixing to the inner side face of the combustion chamber (FIG. 9), whereas the fuel use coefficient stably reached a level of “fuel use coefficient after affixing” within about 2.4 months after affixing in the case of affixing to the outer side face of the combustion chamber (FIG. 8). Herein, as shown from Table 12, a distance between the solid horizontal line and the broken horizontal line in FIG. 8 corresponds to 5.33%, whereas that in FIG. 9 corresponds to 5.53%. As seen from above, in the case of affixing to the inner side face of the combustion chamber (FIG. 9), the fuel use coefficient reached lower “fuel use coefficient after affixing” earlier and higher energy saving effect was exerted earlier, as compared with the case of affixing to the outer side face of the combustion chamber (FIG. 8).

### (9-3) Third Embodiment

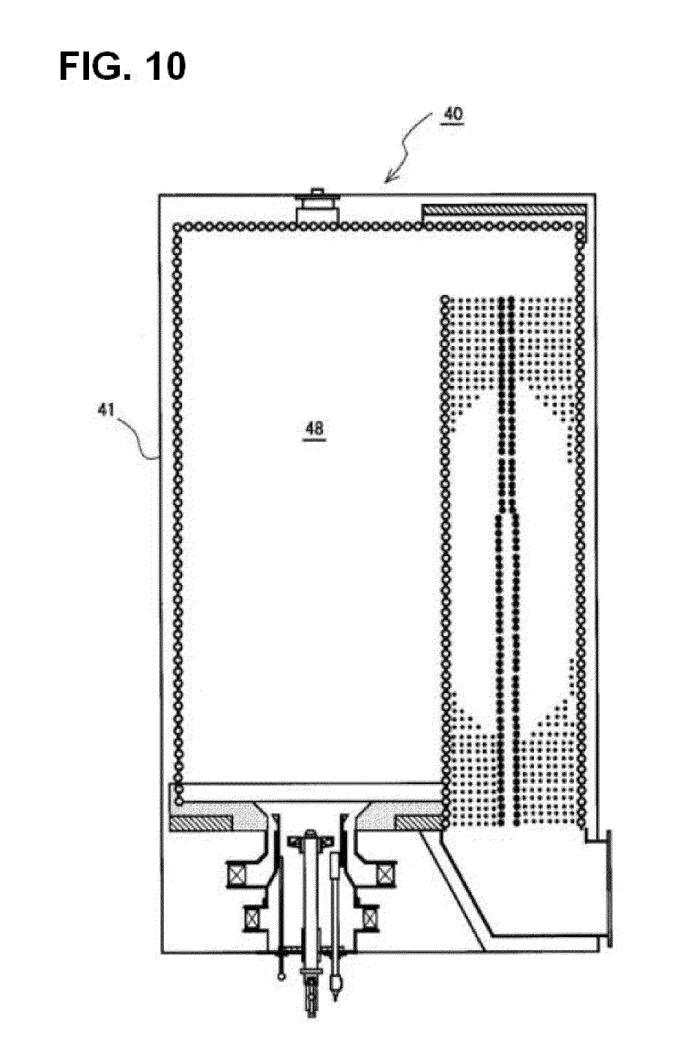

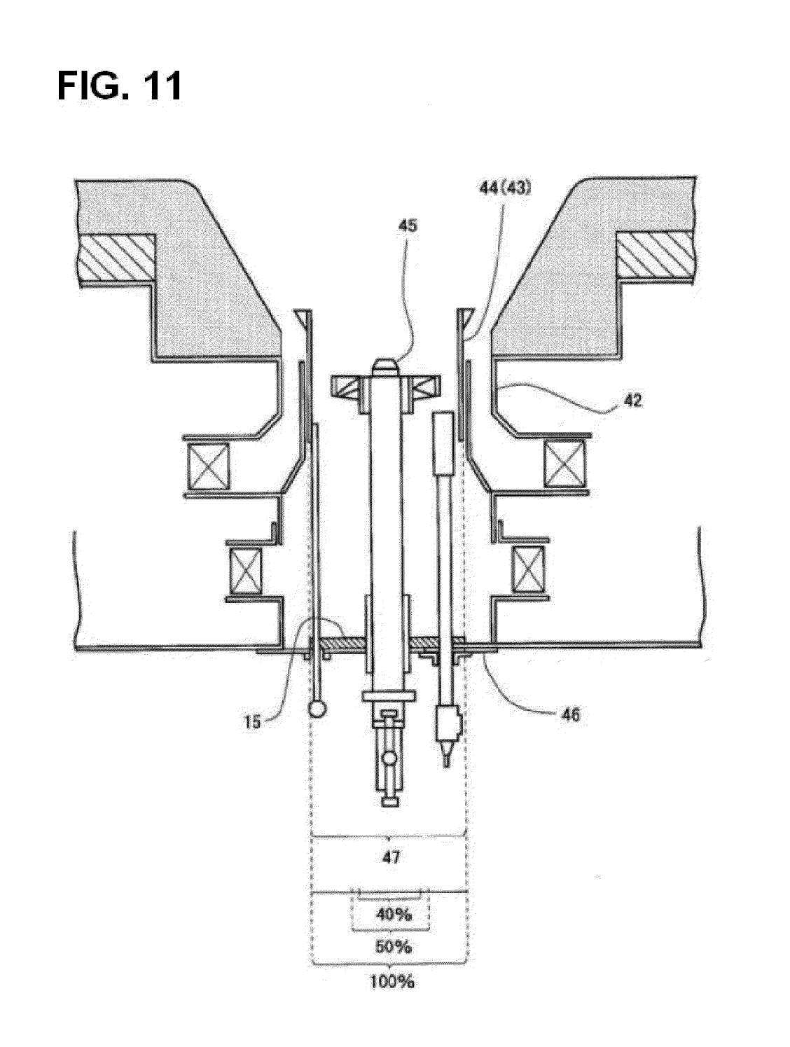

As the third embodiment, verification was conducted using a water-tube boiler as a specific boiler. The fuel used in this water-tube boiler (SCM-160, IHI Corporation) was C-heavy oil, the burner used was a gun type burner, the boiler capacity was 16,000 kg/h, and the control method was a proportional control method. FIG. 10 is a schematic view of the water-tube boiler 40, and FIG. 11 enlarges a gun type burner portion thereof. A combustion device 42 was attached to one end (lower end in FIG. 10) of a combustion chamber 48 in a boiler body 41, and a combustion cone 43 enabled a cone maximum diameter portion 44 having the maximum outer diameter to open toward inside the boiler body 41 (upward in FIG. 10 and FIG. 11), and emitted flame from the tip of gun type burner 45 located in almost the shaft center to a center direction of a combustion chamber 48. A flange 46 that fixed the gun type burner 45 was provided at the rear end of the combustion device 42. Each kind of heat-resistant fuel-activating substances 15 in Table 13 below was affixed onto the inner side face of the flange 46, whose area 47 was 100% of a projected area of the cone maximum diameter portion 44 to the flange 46, and the fuel use coefficient before and after affixing was calculated and then the energy saving ratio was calculated therefrom. The results were shown in Table 13 below. The heat-resistant fuel-activating substances used herein were respectively the same as those used in the first embodiment.

TABLE 13

| Method of affixing | | Fuel use coefficient | | Energy |
|---|---|---|---|---|
| heat-resistant fuel- | Spectral | Before | After | saving rate |
| activating substance | emissivity | affixing | affixing | (%) |
| Metal spraying | 0.90 | 70.50 | 68.31 | 3.11 |
| Metal sheet | 0.88 | 70.52 | 68.35 | 3.08 |
| Inorganic resin | 0.94 | 70.38 | 67.89 | 3.54 |
| sheet | | | | |
| Inorganic resin | 0.92 | 70.42 | 68.05 | 3.37 |
| thermal spray | | | | |

As described above, even in each of the heat-resistant fuel-activating substances, if the spectral emissivity was 0.85 or more, a decrease of at least 3% or more of the fuel use coefficient before affixing was observed. In particular, even if the heat-resistant fuel-activating substance was different, similar to the first and second embodiments described above, there was a tendency that the energy saving rate also increased with the increase of the spectral emissivity of the heat-resistant fuel-activating substance.

Next, in the case of affixing an inorganic material sheet that exhibited the highest energy saving ratio, among the above to each of an inner side face and an outer side face of a flange 46, which occupied 40%, 50% and 100% of the area of the projected part of a cone maximum diameter portion 44, an energy saving ratio was examined. The results are shown in Table 14 below.

TABLE 14

| | | | Spectral | Fuel use coefficient | | Energy |
|---|---|---|---|---|---|---|
| Test | Affixed | | emis- | Before | After | saving |
| No. | position | Area | sivity | affixing | affixing | rate (%) |
| 13 | Outer side face | 40% | 0.94 | 70.47 | 70.45 | 0.03 |
| 14 | Outer side face | 50% | 0.94 | 70.46 | 68.23 | 3.16 |
| 15 | Outer side face | 100% | 0.94 | 70.44 | 68.15 | 3.25 |
| 16 | Inner side face | 40% | 0.94 | 70.45 | 70.40 | 0.07 |
| 17 | Inner side face | 50% | 0.94 | 70.43 | 68.15 | 3.24 |
| 18 | Inner side face | 100% | 0.94 | 70.38 | 67.89 | 3.54 |

It has been found that the energy saving ratio is less than 1% in the tests No. 13 and No. 16 in which the affixed area was less than 50%, and that these sheets did not endure practical use. On the other hand, in each of tests No. 14, No. 15, No. 17 and No. 18 in which the affixed area was 50% or more, it was possible to achieve the energy saving ratio exceeding at least 3%. As shown from a comparison between the tests No. 14 and No. 15 and a comparison between the tests No. 17 and No. 18, the energy saving ratio increased as the affixed area became larger. Moreover, as shown from a comparison between the tests No. 14 and No. 17 and a comparison between the tests No. 15 and No. 18, when the affixed area was the same, the energy saving ratio increased by affixing to the inner side face of the combustion chamber as compared with the case of affixing to the outer side face.

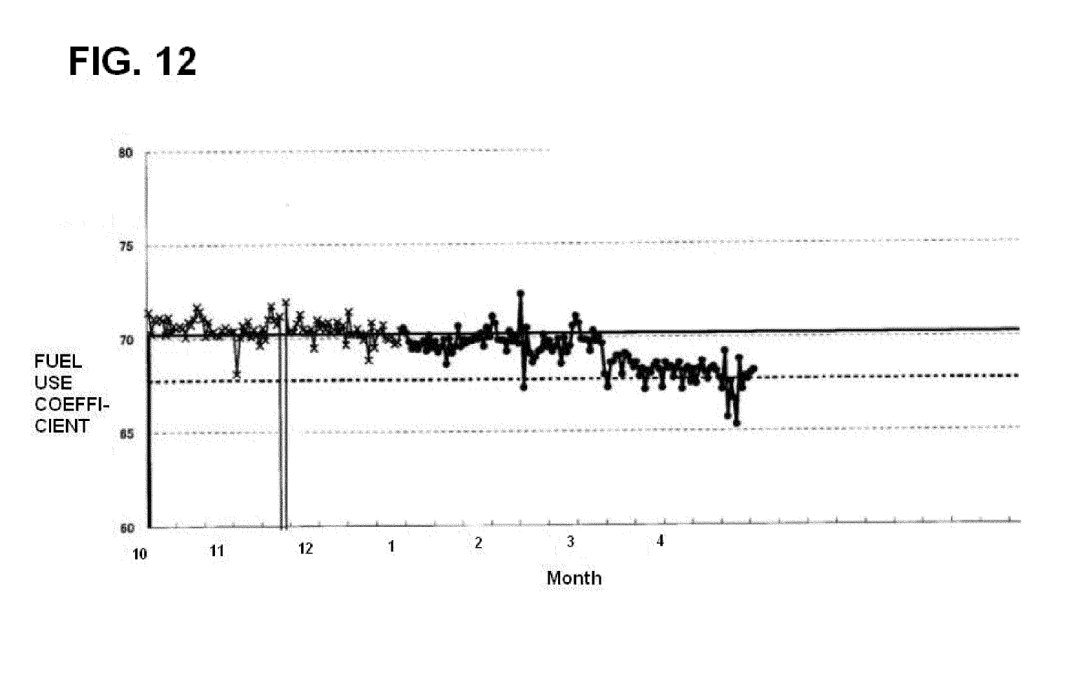

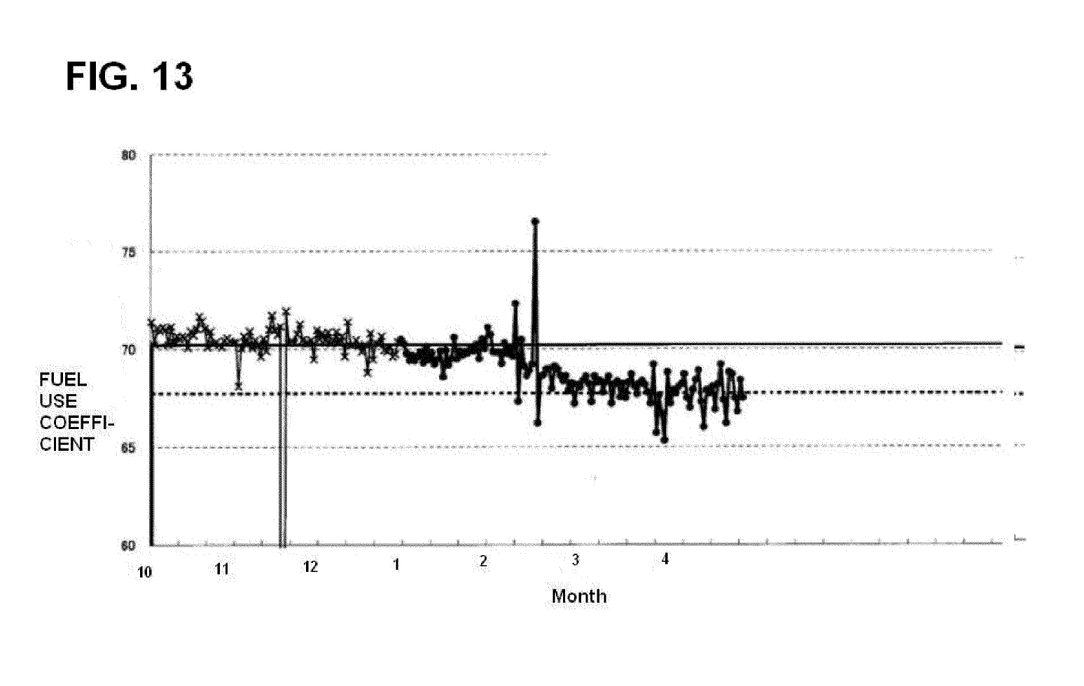

With respect to the tests No. 15 and No. 18 in which the affixed area occupied 100% of the projected area of a cone maximum diameter portion 44, a change in a fuel use coefficient before and after affixing of the heat-resistant fuel-activating substance is shown as a graph in FIG. 12 for the test No. 15, and as a graph in FIG. 13 for the test No. 18.

In both FIG. 12 and FIG. 13, an upper solid horizontal lines in the graphs are drawn at the numerical value of the “fuel use coefficient before affixing” in Table 14, while lower broken horizontal lines are drawn at the numerical value of the “fuel use coefficient after affixing” in the same table. In both drawings, the symbol “×” denotes a plot of the fuel use coefficient before affixing of the heat-resistant fuel-activating substance, while the symbol “∘” denotes a plot of a change in the fuel use coefficient after affixing of the heat-resistant fuel-activating substance.

As seen from both of these drawings, the fuel use coefficient stably reached a level of “fuel use coefficient after affixing” within about 1.9 months after affixing in the case of affixing to the inner side face of the combustion chamber (FIG. 13), whereas the fuel use coefficient stably reached a level of “fuel use coefficient after affixing” within about 2.3 months after affixing in the case of affixing to the outer side face of the combustion chamber (FIG. 12). Herein, as shown from Table 14, a distance between the solid horizontal line and the broken horizontal line FIG. 12 corresponds to 3.25%, whereas that in FIG. 13 corresponds to 3.54%. As seen from above, in the case of affixing to the inner side face of the combustion chamber (FIG. 13), the fuel use coefficient reached lower “fuel use coefficient after affixing” earlier and higher energy saving effect was exerted earlier, as compared with the case of affixing to the outer side face of the combustion chamber (FIG. 12).

### (10) Others

It is additionally noted herein that almost the same effects were obtained even in the case of using boilers other than the above respective general-purpose boilers, industrial boilers and using, in addition to the above fuels, town gas (13A) and biofuel and the like as fuels used in the boilers, regardless of the kind.

### INDUSTRIAL APPLICABILITY

The present invention can be utilized not only in a once-through boiler, a flame-tube smoke-tube boiler and a water-tube boiler (including an industrial boiler and a power station boiler that are equipped with two or more burners), but also in burning appliances equipped with a combustion device, such as a kiln and a dryer.

1. A method of affixing a heat-resistant fuel-activating substance, wherein a heat-resistant fuel-activating substance having a spectral emissivity of 0.85 or more for electromagnetic waves with wavelengths in a range of 3 μm to 20 μm is affixed onto a burning appliance; the heat-resistant fuel-activating substance being affixed in a position which is located outside a combustion device at a back of a combustion flame-generating portion of a burner which constitutes this combustion device so that the substance occupies 50% or more of an area of a projected part of a combustion cone which constitutes this combustion device.

2. A method of affixing a heat-resistant fuel-activating substance, wherein a heat-resistant fuel-activating substance having a spectral emissivity of 0.85 or more for electromagnetic waves with wavelengths in a range of 3 μm to 20 μm is affixed onto a burning appliance; the heat-resistant fuel-activating substance being affixed in a position which is located inside a combustion device, in which continuous flame is generated by burning fuel, at a back of a combustion flame-generating portion of a burner which constitutes this combustion device so that the substance occupies 50% or more of an area of a projected part of a combustion cone which constitutes this combustion device.

3. The method of affixing heat-resistant fuel-activating substance according to claim 1, wherein the burner is fixed to a flange portion which constitutes the combustion device and this flange portion is fixed to this combustion device so that this burner is mounted in this combustion device, and the position which is located outside the combustion device corresponds to a position outside the combustion device at the flange portion fixed to this combustion device.

4. The method of affixing heat-resistant fuel-activating substance according to claim 2, wherein the burner is fixed to a flange portion which constitutes the combustion device and this flange portion is fixed to this combustion device so that this burner is mounted in this combustion device, and the position which is located inside the combustion device corresponds to a position inside the combustion device at the flange portion fixed to this combustion device.

5. A combustion device, wherein a heat-resistant fuel-activating substance having a spectral emissivity of 0.85 or more for electromagnetic waves with wavelengths in a range of 3 μm to 20 μm is affixed in a position which is located inside the combustion device, in which continuous flame is generated by burning fuel, at a back of a combustion flame-generating portion of a burner which constitutes this combustion device so that the substance occupies 50% or more of an area of a projected part of a combustion cone which constitutes this combustion device.
